(19) United States
(12) Patent Application Publication
(10) Pub. No.: US 2004/0142205 A1
(43) Pub. Date: Jul. 22, 2004

(54) Decorative and protective coating

(76) Inventors: Guocun Chen, Broomfield, CO (US); Patrick B. Jonte, Zionsville, IN (US)

Correspondence Address: Lloyd D. Doigan, Masco Corporation, 21001 Van Born Road, Taylor, MI, 48180, US

(21) Appl. No.: 10/348,104

(22) Filed: Jan. 21, 2003

(51) Int. Cl. B32B 15/04

(52) U.S. Cl. 428/689; 428/697; 428/698; 428/702; 428/660

(57) ABSTRACT

An article is coated with a decorative and protective multi-layer coating. The coating comprises a polymeric basecoat layer on the surface of said article, a chromium strengthening layer on said basecoat layer, a strike layer on said strengthening layer, an intermediate oxide layer on said strike layer, a stack layer comprised of layers of chromium, refractory metal or refractory metal alloy alternating with layers of chromium compound, refractory metal compound or refractory metal alloy compound, a color and protective layer comprised of chromium compound, refractory metal compound or refractory metal alloy compound on said stack layer, and a top oxide layer on said color and protective layer. The intermediate oxide layer acts as a non-conductive barrier layer and improves corrosion and pitting resistance.

### FIELD OF THE INVENTION

This invention relates to articles having a multi-layered decorative and protective coating thereon.

### BACKGROUND OF THE INVENTION

It is currently the practice with various brass articles such as lamps trivets, candlesticks, door knobs and handles and the like to first buff and polish the surface of the article to a high gloss and to then apply a protective organic coating, such as one comprised of acrylics, urethanes, epoxies, and the like, onto this polished surface. While this system is generally quite satisfactory it has the drawback that the buffing and polishing operation, particularly if the article is of a complex shape, is labor intensive. Also, the known organic coatings are not always as durable as desired, particularly in outdoor applications where the articles are exposed to the elements and ultraviolet radiation.

The problems with organic coatings have been overcome by the application of physical vapor deposited coatings. However, even with these coatings there is a problem with corrosion and pitting, particularly after an extended period of use in aggressive environments such as tropical coastal areas. The present invention provides vapor deposited coatings which have improved corrosion resistance and reduced pitting.

### SUMMARY OF THE INVENTION

The present invention is directed to an article, such as a plastic, ceramic, cermet or metallic article, having a multi-layer coating on at least a portion of its surface. More particularly, it is directed to an article or substrate, particularly a metallic article such as stainless steel, aluminum, brass or zinc, having deposited in at least a portion of its surface a coating comprised of multiple superposed layers of certain specific types of materials. The coating is decorative and also provides corrosion resistance, wear resistance and improved chemical resistance.

The article has deposited on its surface a polymeric basecoat layer. The polymeric basecoat layer functions to level the surface of the article, cover any scratches or imperfections in the surface of the article, provide a smooth and even surface for the deposition of the subsequent layers of the multi-layered coatings, and provide improved corrosion resistance.

In one embodiment over the polymeric basecoat layer is applied a metal, such as chromium, or metal alloy, such as tin-nickel alloy, layer. Over this chromium or metal alloy layer is applied a chromium or refractory metal or refractory metal alloy strike layer. Over this strike layer is applied an intermediate chromium oxide, refractory metal oxide or refractory metal alloy oxide layer. Over this intermediate oxide layer is applied a stack layer comprised of layers of chromium compound, refractory metal compound or refractory metal alloy compound alternating with layers comprised of chromium, refractory metal or refractory metal alloy. Over the stack layer is applied a protective color layer comprised of a chromium compound, refractory metal compound or refractory metal alloy compound such as a nitride, oxy-nitride, carbide or carbonitride. Over the color layer is a thin chromium oxide, refractory metal oxide or refractory metal alloy oxide top layer.

### BRIEF DESCRIPTION OF THE DRAWINGS

FIG. 1 is a cross-sectional view, not to scale, of the coated article of the instant invention wherein the coating comprises a polymeric basecoat layer, a strike layer, an intermediate oxide layer, a stack layer comprised of alternating layers of a refractory metal and refractory or refractory metal compound layer or refractory metal alloy compound layer, a color layer and a top oxide layer; and

FIG. 2 is similar to FIG. 1 except that a chromium or metal alloy layer is present intermediate the nickel layer and the strike layer.

### DESCRIPTION OF THE PREFERRED EMBODIMENT

The article or substrate 12 can be comprised of any material such as plastic, ceramic, cermet, metal or metallic alloy. In one embodiment it is a metal or metal alloy such as copper, steel, brass, zinc, aluminum, nickel alloys, and the like. In preferred embodiments the substrate is brass or zinc.

Over the surface of the article 12 is deposited a base coat layer 13 comprised of a polymeric material. The polymeric or resinous layer or base coat 13 may be comprised of both thermoplastic and thermoset polymeric or resinous material. These polymeric or resinous materials include the well known, conventional and commercially available polyacrylates, polymethacrylates, polyepoxies, alkyds, polyurethanes, and styrene containing polymers such as polystyrene and styrene-acrylonitrile (SAN), and blends and copolymers thereof.

The polyacrylates and polymethacrylates are polymers or resins resulting from the polymerization of one or more acrylates such as, for example, methyl acrylate, ethyl acrylate, butyl acrylate, 2-ethylhexyl acrylate, etc., as well as the methacrylates such as, for instance, methyl methacrylate, ethyl methacrylate, butyl methacrylate, hexyl methacrylate, etc. Copolymers of the above acrylate and methacrylate monomers are also included within the term “polyacrylates or polymethacrylates” as it appears herein. The polymerization of the monomeric acrylates and methacrylates to provide the polyacrylate resins useful in the practice of the invention may be accomplished by any of the well known polymerization techniques.

The styrene-acrylonitrile resins and their preparation are disclosed, inter alia, in U.S. Pat. Nos. 2,769,804; 2,989,517; 2,739,142; 3,935,152 and 4,291,134, all of which are incorporated herein by reference.

The alkyd resins are disclosed in “Alkyd Resin Technology”, Patton, Interscience Publishers, NY, N.Y., 1962, and in U.S. Pat. Nos. 3,102,866; 3,228,787 and 4,511,692, all of which are incorporated herein by reference.

Polyurethanes are well known in the art and are readily commercially available. Various known polyols and polyisocyanates are used to form polyurethanes. Polyurethanes are described, for example, in Chapter X, Coatings, pp. 453-607 in J. H. Saunders and K. C. Frisch, Polyurethanes: Chemistry and Technology, Part II, Interscience Publishers (NY, 1964), incorporated herein by reference.

Suitable polyurethanes may be prepared in a conventional manner such as by reacting polyols or hydroxylated polymers with organic polyisocyanates in the manner well known in the art. Suitable organic polyisocyanates include, for instance, ethyl diisocyanate; ethylidene diisocyanate; propylene-1, 2-diisocyanate; cyclohexylene-1, m-phenylene diisocyanate; 2,4-toluene diisocyanate; 2,6-toluene diisocyanate; 3,3′-dimethyl-4, 4′-biphenyl diisocyanate; p,p′,p″-triphenylmethane triisoene diisocyanate; 4′-biphenylene diisocyanate; 4,4′-biphenylene diisocyanate; 3,3′-dichloro-4, 4-biphenylene diisocyanate; p,p′,p″-triphenylmethane triisocyanate; 1,5-mepthalene diisocyanate; furfurylidene diisocyanate or polyisocyanates, in blocked or inactive form such as bis-phenyl carbamates or 2,4- or 2,6-toluene diisocoyanate; p,p″-diphenyl methane diisocyanate; p-phenylene diisocyanate; 1,5-napthalene diisocyanate and the like. It is preferred to use a commercially available mixture of toluene diisocyanates which contains 80 percent 2,4-toluene diisocoyanate and 20 percent 2,6-toluene diisocyanate or 4,4-diphenylmethane diisocyanate.

Polyurethanes applied as base coats in accordance with the invention may, of course, be in the form of solutions in suitable solvents such as xylene, toluene, methyl ethyl ketone, butanol, butyl acetate, etc.

Materials for the polyurethane base coats may be supplied in one package or two package prepolymer systems or oil modified systems, etc., all in the manner well known in the industry. Such materials are described for instance in the pamphlet “Urethane Coatings”, published by the Federation of Societies for Paint Technology (1970). Radiation-curable urethane coatings may also of course be used.

Some illustrative examples of suitable polyurethane compositions are disclosed in U.S. Pat. Nos. 4,699,814; 4,681,811; 4,703,101; 4,403,003 and 5,268,215, all of which are incorporated herein by reference.

Another suitable type of polyurethane is an acrylic polyurethane. The acrylic polyurethanes are described in U.S. Pat. Nos. 3,558,564; 4,131,571 and 4,555,535, all of which are incorporated herein by reference.

The polyepoxies are disclosed in “Epoxy Resins”, by H. Lee and K. Nevill, McGraw-Hill, New York, 1957, and in U.S. Pat. Nos. 2,633,458; 4,988,572; 4,734,468; 4,680,076; 4,933,429 and 4,999,388, all of which are incorporated herein by reference.

Some suitable epoxy resins include glycidyl ethers of polyhydric phenols and polyhydric alcohols prepared by the reaction of epichlorohydrin with a compound containing at least one hydroxyl group, such as for example bisphenol-A, carried out under alkaline reaction conditions.

Other suitable epoxy resins can be prepared by the reaction of epichlorohydrin with mononuclear di- and tri-hydroxy phenolic compounds such as resorcinol and phloroglucinol, selected polynuclear polyhydroxy phenolic compounds such as bis(phydroxyphenyl)methane and 4,4′-dihydroxybiphenyl, or aliphatic polyols such as 1,4-butanediol and glycerol.

These epoxy resins include the glycidyl polyethers of polyhydric phenols and polyhydric alcohols, particularly the glycidyl polyethers or 2,2-bis(4-hydroxyphenyl)propane.

Also useful as polymeric basecoat are the epoxy urethanes. The epoxy urethane based polymers and their preparation are well known and commercially available materials and are disclosed, inter alia, in U.S. Pat. Nos. 3,963,663; 4,705,841; 4,035,274; 4,052,280; 4,066,523; 4,159,233; 4,163,809; 4,229,335; 3,947,339; 3,891,527 and 3,970,535, all of which are incorporated by reference. Particularly useful epoxy urethane based polymers or resins are those that are electrocoated onto the article. Such electrodepositable epoxy urethane based resins are described in the aforementioned U.S. Pat. Nos. 3,963,663; 4,066,523; 4,159,233; 4,035,274; 3,947,339 and 4,070,258, incorporated herein by reference.

An example of an epoxy urethane resin which can be applied on an article comprises a polyepoxide, such as a diepoxide, reacted with diisocyanate, preferably in a molar ratio of about 2 mols of the polyepoxide per mol of diisocyanate to provide an epoxy urethane. This epoxy urethane is then coated on the article by any of the conventional and well known means such as, for example, by brushing, spraying, dipping and the like. If the epoxy urethane is to be electrocoated or electrodeposited on the article, which is the cathode, a hydroxy functional polyepoxide, such as a diepoxide, is adducted with diisocyanate, preferably in a molar ratio of about 2 mols of the polyepoxide per mol of the diisocyanate, to provide an epoxy urethane containing unreacted epoxy groups. This epoxy urethane is then adducted with an amine, preferably a polyamine, and more preferably a diprimary amine, in an amount effective to provide 1 mol of the amine per epoxy equivalent. In this way the epoxy functionality is eliminated, hydroxy functionality is generated, and the product contains amine functionality. This hydroxy functional polyamine may be precondensed with phenolic resin and employed in cathodic electrocoating.

These polymeric materials may optionally contain the conventional and well known fillers such as mica, talc and glass fibers.

The polymeric or resinous layer or basecoat layer 13 is applied onto the substrate 12 by any of the well known and conventional methods such as dipping, spraying, brushing, electrostatic spraying and electrocoating.

Layer 13 functions, inter alia, to level the surface of the substrate, cover any scratches or imperfections in the surface, provide a smooth and even surface for the deposition of the subsequent layers, and provide corrosion resistance to the substrate.

The basecoat layer 13 has a dry or cured thickness at least effective to provide corrosion resistance and to level out the surface of the substrate. Generally this thickness is from about 2 μm to about 300 μm, preferably from about 5 μm to about 150 μm, and more preferably from about 7 μm to about 35 μm.

In one embodiment, as illustrated in FIG. 2, deposited over polymeric layer 13 is a layer 22 comprised of chromium. The chromium layer 22 may be deposited on layer 13 by plating or vapor deposition such as physical vapor deposition. Plating includes electroplating. The chrome electroplating techniques along with various chromium plating baths are well known and conventional and are disclosed, inter alia, in Brassard, “Decorative Electroplating—A Process in Transition”, Metal Finishing, pp. 105-108, June 1988; Zaki, “Chromium Plating”, PF Directory, pp. 146-160; and in U.S. Pat. Nos. 4,460,438; 4,234,396 and 4,093,522, all of which are incorporated herein by reference.

Chromium plating baths are well known and commercially available. A typical chromium plating bath contains chromic acid or sales thereof, and catalyst ion such as sulfate or fluoride. The catalyst ions can be provided by sulfuric acid or its salts and fluosilicic acid. The baths may be operated at a temperature of about 112°-116° F. Typically in chrome plating a current density of about 150 amps per square foot, at about 5 to 9 volts is utilized.

The chromium layer 22 is a strengthening layer and serves to provide structural integrity to the coating or reduce or eliminate plastic deformation of the coating. The polymer layer 13 is relatively soft compared to the refractory metal compound color layer 50. Thus, an object impinging on, striking or pressing on layer 50 will not penetrate this relatively hard layer, but this force will be transferred to the relatively soft underlying polymer layer 13 causing plastic deformation of this layer. Chromium strengthening layer 22, being relatively harder than the underlying polymer layer, will generally resist the plastic deformation that the polymer layer 13 undergoes.

Chromium layer 22 has a thickness at least effective to provide structural integrity to and reduce plastic deformation of the coating. This thickness is at least about 0.05 μm, preferably at least about 0.1 μm, and more preferably at least about 0.2 μm. Generally, the upper range of thickness is not critical and is determined by secondary considerations such as cost. However, the thickness of the chrome layer should generally not exceed about 5 μm, preferably about 2 μm, and more preferably about 1 μm.

Instead of layer 22 being comprised of chromium it may be comprised of tin-nickel alloy, palladium-nickel alloy or nickel-tungsten-boron alloy.

The tin-nickel layer may be deposited by plating such as electroplating or vapor deposition such as physical vapor deposition. If the tin-nickel layer is deposited by electroplating it is deposited by conventional and well known tin-nickel electroplating processes. These processes and plating baths are described, inter alia, in U.S. Pat. Nos. 4,033,835; 4,049,508; 3,887,444; 3,772,168 and 3,940,319, all of which are incorporated herein by reference.

The tin-nickel alloy layer is preferably comprised of about 60-70 weight percent tin and about 30-40 weight percent nickel, more preferably about 65% tin and 35% nickel representing the atomic composition SnNi. The plating bath contains sufficient amounts of nickel and tin to provide a tin-nickel alloy of the afore-described composition.

A commercially available tin-nickel plating process is the Ni-Colloy™ process available from ATOTECH, and described in their Technical Information Sheet No: NiColloy, Oct. 30, 1994, incorporated herein by reference.

The nickel-tungsten-boron alloy layer may be deposited by plating such as electroplating or vapor deposition such as physical vapor deposition. If the nickel-tungsten-boron alloy layer is deposited by electroplating, it is deposited by conventional and well known nickel-tungsten-boron electroplating processes. The plating bath is normally operated at a temperature of about 115° to 125° F. and a preferred pH range of about 8.2 to about 8.6. The well known soluble, preferably water soluble, salts of nickel, tungsten and boron are utilized in the plating bath or solution to provide concentrations of nickel, tungsten and boron.

The amorphous nickel-tungsten-boron alloy layer generally contains at least 50, preferably at least about 55, and more preferably at least 57.5 weight percent nickel, at least about 30, preferably at least about 35, and more preferably at least 37.5 weight percent tungsten, and at least about 0.05, preferably at least about 0.5, and more preferably at least about 0.75 weight percent boron. Generally the amount of nickel does not exceed about 70, preferably about 65, and more preferably about 62.5 weight percent, the amount of tungsten does not exceed about 50, preferably about 45, and more preferably about 42.5 weight percent, and the amount of boron does not exceed about 2.5, preferably about 2, and more preferably about 1.25 weight percent. The plating bath contains sufficient amounts of the salts, preferably soluble salts, of nickel, tungsten and boron to provide a nickel-tungsten-boron alloy of the afore-described composition.

A nickel-tungsten-boron plating bath effective to provide a nickel-tungsten-boron alloy of which a composition is commercially available, such as the Amplate™ system from Amorphous Technologies International of Laguna Niguel, Calif. A typical nickel-tungsten-boron alloy contains about 59.5 weight percent nickel, about 39.5 weight percent tungsten, and about 1% boron. The nickel-tungsten-boron alloy is an amorphous/nano-crystalline composite alloy. Such an alloy layer is deposited by the AMPLATE plating process marketed by Amorphous Technologies International.

The palladium-nickel alloy layer may be deposited by plating such as electroplating or vapor deposition such as physical vapor deposition. If the palladium-nickel alloy layer is deposited by electroplating, it is deposited by conventional and well known palladium-nickel electroplating process. Generally, they include the use of palladium salts or complexes such as nickel amine sulfate, organic brighteners, and the like. Some illustrative examples of palladium/nickel electroplating processes and baths are described in U.S. Pat. Nos. 4,849,303; 4,463,660; 4,416,748; 4,428,820 and 4,699,697, all of which are incorporated by reference.

The weight ratio of palladium to nickel in the palladium/nickel alloy is dependent, inter alia, on the concentration of palladium (in the form of its salt) in the plating bath. The higher the palladium salt concentration or ratio relative to the nickel salt concentration in the bath the higher the palladium ratio in the palladium/nickel alloy.

The palladium/nickel alloy layer generally has a weight ratio of palladium to nickel of from about 50:50 to about 95:5, preferably from about 60:40 to about 90:10, and more preferably from about 70:30 to about 85:15.

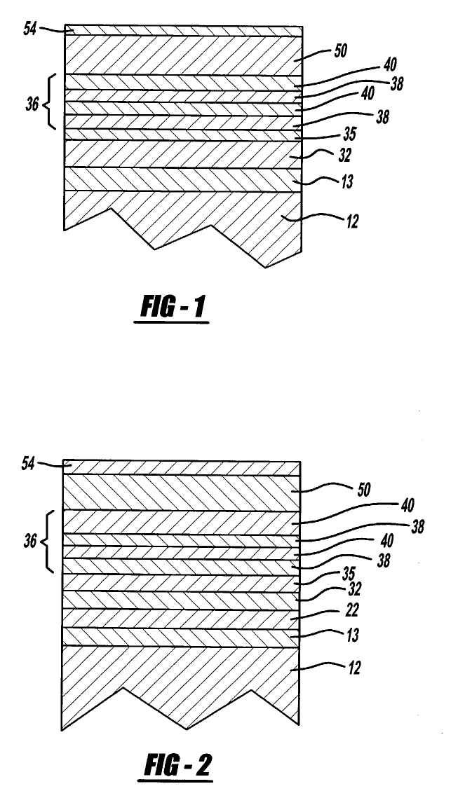

Over layer 22, if layer 22 is present, otherwise over polymeric basecoat layer 13 in the embodiment where layer 22 is not present (as illustrated in FIG. 1), is disposed strike layer 32 comprised of chromium or a refractory metal or metal alloy such as hafnium, tantalum, zirconium, titanium or zirconium-titanium alloy, preferably zirconium, titanium or zirconium-titanium alloy, and more preferably zirconium or zirconium-titanium alloy.

Layer 32 is deposited by conventional and well known techniques including vapor deposition such as cathodic arc evaporation (CAE) or sputtering, and the like. Sputtering and CAE techniques and equipment are disclosed, inter alia, in J. Vossen and W. Kern “Thin Film Processes II”, Academic Press, 1991; R. Boxman et al, “Handbook of Vacuum Arc Science and Technology”, Noyes Pub., 1995; and U.S. Pat. Nos. 4,162,954 and 4,591,418, all of which are incorporated herein by reference.

Briefly, in the sputtering deposition process a chrome or refractory metal (such as titanium or zirconium) target, which is the cathode, and the substrate are placed in a vacuum chamber. The air in the chamber is evacuated to produce vacuum conditions in the chamber. An inert gas, such as Argon, is introduced into the chamber. The gas particles are ionized and are accelerated to the target to dislodge titanium or zirconium atoms. The dislodged target material is then typically deposited as a coating film on the substrate.

In cathodic arc evaporation, an electric arc of typically several hundred amperes is struck on the surface of a metal cathode such as zirconium or titanium. The arc vaporizes the cathode material, which then condenses on the substrates forming a coating.

Layer 32 has a thickness which is generally at least effective to function as a strike layer and improve the adhesion of the stack layer 36 and color layer 50 to the underlying layer(s). This thickness is generally at least about 50 Å, preferably at least about 120 Å, and more preferably at least about 250 Å. The upper thickness range is not critical and is generally dependent upon secondary considerations such as cost. Generally, however, layer 32 should not be thicker than about 1.5 μm, preferably about 0.5 μm, and more preferably about 0.25 μm.

In a preferred embodiment of the present invention strike layer 32 is comprised of titanium, zirconium or zirconium-titanium alloy, preferably zirconium or zirconium-titanium alloy, and is deposited by sputtering or cathodic arc evaporation.

Over strike layer 32 is an intermediate oxide layer 35. Intermediate oxide layer 35 is comprised of chromium oxide, refractory metal oxide or refractory metal alloy oxide, e.g., chromium oxide, zirconium oxide, titanium oxide, zirconium-titanium alloy oxide. Intermediate oxide layer 35 functions inter alia to improve corrosion resistance, reduce pitting, and acts as a non-conductive barrier layer free of macroparticles.

Intermediate oxide layer 35 is deposited by reactive physical vapor deposition such as reactive cathodic arc evaporation and reactive sputtering. These are generally similar to ordinary sputtering and cathodic arc evaporation except that a reactive gas is introduced into the chamber which reacts with the dislodged target material. Thus, in the case where zirconium oxide is intermediate oxide layer 35, the cathode is comprised of zirconium, and oxygen is the reactive gas introduced into the chamber.

The thickness of the intermediate oxide layer 35 is a thickness effective to improve corrosion resistance and reduce pitting. This thickness is from about 50 Å to about 800 Å, preferably from about 100 Å to about 300 Å. If the oxide layer is thinner than about 50 Å, there is little, if any, barrier effect or improvement in corrosion resistance and reduction of pitting. If, on the other hand, the intermediate oxide layer 35 is thicker than about 800 Å, the scratch resistance and corrosion resistance of the coating are degraded, and the undesirable stresses in the coating are increased.

Preferably intermediate oxide layer 35 contains a stoichiometric amount of oxygen. It is to be understood that intermediate oxide layer 35 can in general, contain a substoichiometric amount of oxygen, e.g., 2-50 atomic percent.

Over intermediate oxide layer is a stack layer 36. Stack layer 36 is comprised of layers 40 of chromium compound, refractory metal compound or refractory metal alloy compound alternating with layers 38 of chromium, refractory metal or refractory metal alloy. The chromium compounds, refractory metal compounds and refractory metal alloy compounds are the nitrides, carbides and carbonitrides, e.g. chromium nitride, chromium carbide, zirconium carbonitride, titanium nitride and zirconium-titanium alloy carbonitride.

The stack layer 36 generally has an average thickness of from about 1,000 Å to about 1 μm, preferably from about 0.1 μm to about 0.9 μm, and more preferably from about 0.15 μm to 0.75 μm. The stack layer generally contains from about 2 to about 100 alternating layers 38 and 40, preferably from about 4 to about 50 alternating layers 38 and 40.

Each of the layers 38 and 40 generally has a thickness of at least about 25 Å, preferably at least about 50 Å, and more preferably at least about 100 Å. Generally, layers 38 and 40 should not be thicker than about 0.38 μm, preferably about 0.25 μm, and more preferably abut 0.1 μm.

A method of forming the stack layer 36 is by utilizing sputtering or cathodic arc evaporation to deposit a layer 38 of chromium refractory metal such as zirconium or titanium or refractory metal alloy followed by reactive sputtering or reactive cathodic arc evaporation to deposit a layer of 42, e.g., chromium compound, refractory metal compound such as a refractory metal nitrogen containing compound such as zirconium nitride or titanium nitride, or refractory metal alloy compound.

Preferably the flow rate of reactive gas such as nitrogen gas is varied (pulsed) during vapor deposition such as reactive sputtering between zero (no gas is introduced) to the introduction of gas at a desired value to form multiple alternating layers of metal 38 and metal compound such as metal nitrogen containing compound 40 in the sandwich layer 36.

Over stack layer 36 is deposited, by reactive vapor deposition such as reactive physical vapor deposition, a protective and decorative color layer 50 comprised of a chromium compound, refractory metal compound or refractory metal alloy compound. The chromium compound, refractory metal compound and refractory metal alloy compound include the nitrides, oxy-nitrides (reaction products of metal, oxygen and nitrogen), carbides and carbonitrides.

Some illustrative, non-limiting examples of these compounds include chromium nitride, chromium carbide, chromium oxy-nitride, chromium carbonitride, titanium nitride, hafnium carbide, zirconium-titanium alloy carbide, zirconium nitride and titanium carbonitride.

Color layer 50 provides wear and abrasion resistance and the desired color or appearance. Color and protective layer 50 is deposited on stack layer 36 by any of the well known and conventional vapor deposition techniques, for example physical vapor deposition techniques such as reactive sputtering and cathodic arc evaporation.

Color and protective layer 50 has a thickness at least effective to provide wear and abrasion resistance and the desired color or appearance. Generally, this thickness is at least about 1,000 Å, and more preferably at least about 2,500 Å. The upper thickness range is generally not critical and is dependent upon secondary considerations such as cost. Generally a thickness of about 1 μm, and preferably about 0.5 μm should not be exceeded.

Over color layer 50 is an oxide top layer 54. Oxide top layer 54 is comprised of chromium oxide, refractory metal oxides or refractory metal alloy oxides. The refractory metal oxides and refractory metal alloy oxides of which layer 54 is comprised include, but are not limited to, hafnium oxide, tantalum oxide, zirconium oxide, titanium oxide, and zirconium-titanium alloy oxide.

Oxide top layer 54 generally provides improved chemical resistance and is necessary for intermediate oxide layer 35 to function effectively. If top oxide layer 54 is absent, intermediate oxide layer 35 will not provide sufficiently improved corrosion and pitting resistance. Oxide top layer 54 is generally thin enough to be transparent or translucent so that the color of color layer 50 can be seen through layer 54, but thick enough to provide improved chemical resistance. Generally, this thickness is at least about 1 nm, preferably at least about 5 nm. The thickness should generally not be greater than about 50 nm, preferably not greater than about 25 nm in order to avoid changing the color of color layer 50 or producing interference reflections.

In order that the invention may be more readily understood the following example is provided. The example is illustrative and does not limit the invention thereto.

### EXAMPLE

Brass door handles are placed in a conventional soak cleaner bath containing the standard and well known soaps, detergents, defloculants and the like which is maintained at a pH of 8.9-9.2 and a temperature of 180-200° F. for about 10 minutes. The brass door handles are then placed in a conventional ultrasonic alkaline cleaner bath. The ultrasonic cleaner bath has a pH of 8.9-9.2, is maintained at a temperature of about 160-180° F., and contains the conventional and well known soaps, detergents, defloculants and the like. After the ultrasonic cleaning the handles are rinsed and dried.

A basecoat polymeric composition is applied onto the cleaned and dried handles by a standard and conventional high volume low pressure gun. The polymer is comprised of 35 weight percent styrenated acrylic resin, 30 weight percent melamine formaldehyde resin, and 35 weight percent bisphenol A epoxy resin. The polymer is dissolved in sufficient solvents to provide a polymeric composition containing about 43 weight percent solids. After the basecoat is applied onto the handles the handles are allowed to sit for 20 minutes for ambient solvent flash off. The handles are then baked at 375° F. for two hours. The resulting cured polymeric basecoat has a thickness of about 20 μm.

The door handles with the polymeric basecoat are placed in a conventional, commercially available hexavalent chromium plating bath using conventional chromium plating equipment for about seven minutes. The hexavalent chromium bath is a conventional and well known bath which contains about 32 ounces/gallon of chromic acid. The bath also contains the conventional and well known chromium plating additives. The bath is maintained at a temperature of about 112-116° F., and utilizes a mixed sulfate/fluoride catalyst. The chromic acid to sulfate ratio is about 200:1. A chromium layer of about 0.25 μm is deposited on the surface of the bright nickel layer. The handles are thoroughly rinsed in deionized water and then dried.

The chromium plated handles are placed in a cathodic arc evaporation plating vessel. The vessel is generally a cylindrical enclosure containing a vacuum chamber which is adapted to be evacuated by means of pumps. A source of argon is connected to the chamber by an adjustable valve for varying the rate of flow of argon into the chamber. In addition, sources of nitrogen and oxygen gases are connected to the chamber by adjustable valves for varying the flow rates of nitrogen and oxygen into the chamber.

A cylindrical cathode is mounted in the center of the chamber and connected to negative outputs of a variable D.C. power supply. The positive side of the power supply is connected to the chamber wall. The cathode material comprises zirconium.

The door handles are mounted on spindles, 16 of which are mounted on a ring around the outside of the cathode. The entire ring rotates around the cathode while each spindle also rotates around its own axis, resulting in a so-called planetary motion which provides uniform exposure to the cathode for the multiple handles mounted around each spindle. The ring typically rotates at several rpm, while each spindle makes several revolutions per ring revolution. The spindles are electrically isolated from the chamber and provided with rotatable contacts so that a bias voltage may be applied to the substrates during coating.

The vacuum chamber is evacuated to a pressure of about 10⁻⁵ to 10⁻⁷ torr.

The door handles are then subjected to a high-bias arc plasma cleaning in which a (negative) bias voltage of down to minus 600 volts is applied to the handles while an arc of approximately up to 500 amperes is struck and sustained on the cathode. The duration of the cleaning is approximately three minutes.

Argon gas is introduced at a rate sufficient to maintain a pressure of about 1 to 5 millitorr. A layer of zirconium having an average thickness of about 0.1 μm is deposited on the door handles during a five minute period. The cathodic arc deposition process comprises applying D.C. power to the cathode to achieve a current flow of up to 500 amps, introducing argon gas into the vessel to maintain the pressure in the vessel at about 1 to 5 millitorr and rotating the handles in a planetary fashion described above.

After the zirconium layer is deposited, a non-conductive zirconium oxide barrier layer is deposited on the zirconium metal layer. A flow of oxygen is introduced into the vacuum chamber while the arc discharge is maintained at a designated current value for 5 minutes. The flow ratio of oxygen to argon should be maintained such that a stable arc plasma is maintained while no charging builds up on the target surface that prevents further formation of plasma, and a stoichiometric zirconium oxide barrier layer is deposited. Normally, this zirconium oxide layer is preferably between 100 Å to 300 Å thick to act as an efficient non-conductive barrier layer to improve corrosion and pitting resistance.

On the top the zirconium oxide layer, a stack of alternating layers of a zirconium metal and substoichiometric zirconium nitride layer and a stoichiometric zirconium nitride layer is deposited. A flow of nitrogen is introduced into the chamber and varied such that a thin layer of zirconium metal and substoichiometric zirconium nitride is produced when the nitrogen flow is decreased and a thin layer of stoichiometric zirconium nitride is produced when the nitrogen flow is sufficient.

On the stack layers of alternative mixture of zirconium metal and substoichiometric zirconium nitride layer and stoichiometric zirconium nitride layer, a zirconium nitride, substoichiometric nitride or oxy-nitride color layer is deposited. A flow of nitrogen or nitrogen and oxygen is introduced into the vacuum chamber while the arc discharge continues at approximately 500 amperes. In production of a brass color zirconium nitride, the flow of nitrogen is a flow which will produce zirconium nitride layer having nitrogen content of about 35 to 50 atomic percent. In production of nickel or stainless steel color, substoichiometric zirconium nitride or zirconium oxy-nitride when flow of nitrogen and oxygen results in total nitrogen and oxygen content of 14 to 35 atomic percent in the zirconium nitride and oxide layer. The zirconium nitride or nitride and oxide color layer have a thickness of about 1,500 Å to 7,500 Å.

After this color layer is deposited the nitrogen flow is terminated and a flow of oxygen of approximately 30 to 70 standard liters per minute is introduced for a time of about 10 to 60 seconds. A thin layer of zirconium oxide with a thickness of about 10 Å to 100 Å is formed. The arc is extinguished, the vacuum chamber is vented and the coated articles removed.

While certain embodiments of the invention have been described for purposes of illustration, it is to be understood that there may be various embodiments and modifications within the general scope of the invention.

We claim:

1. An article having on at least a portion of its surface a decorative and protective multi-layer coating comprising:
polymeric basecoat layer;
adhesion promoting strike layer comprised of chromium, refractory metal or refractory metal alloy;
intermediate oxide layer comprised of chromium oxide, refractory metal oxide or refractory metal alloy oxide;
stack layer comprised of layers of chromium, refractory metal or refractory metal alloy alternating with layers of chromium compound, refractory metal compound or refractory metal alloy compound;
color layer comprised of chromium compound, refractory metal compound or refractory metal alloy compound; and
top oxide layer comprised of chromium oxide, refractory metal oxide or refractory metal alloy oxide.

2. The article of claim 1 wherein a strengthening layer comprised of chromium or metal alloy is intermediate said basecoat layer and said strike layer.

3. The article of claim 1 wherein said intermediate oxide layer has a thickness at least effective to improve corrosion resistance, reduce pitting, and function as a non-conductive barrier layer free of macroparticles.

4. The article of claim 3 wherein said thickness is from about 50 Å to about 800 Å.

5. The article of claim 3 wherein said top oxide layer has a thickness at least effective to provide improved chemical resistance.

6. The article of claim 1 wherein the chromium compounds, refractory metal compounds or refractory metal alloy compounds are selected from the group consisting of the nitrides, carbides, carbonitrides and oxy-nitrides.

7. The article of claim 6 wherein said oxy-nitrides are comprised of the reaction products of chromium, refractory metal or refractory metal alloy, oxygen and nitrogen.

8. The article of claim 6 wherein said compounds are selected from the group consisting of nitrides, carbides and carbonitrides.
